(19) United States
(12) Patent Application Publication
(10) Pub. No.: US 2011/0051986 A1
(43) Pub. Date: Mar. 3, 2011

(54) Magnetic System for an Electroacoustic Transducer

(75) Inventor: Tilman Koch, Uttenreuth (DE)

(73) Assignee: beyerdynamic GmbH & Co. KG, Heilbronn (DE)

(21) Appl. No.: 12/868,584

(22) Filed: Aug. 25, 2010

(30) Foreign Application Priority Data
Aug. 26, 2009 (DE) 10 2009 038 593.2

(51) Int. Cl. H04R 9/06

(52) U.S. Cl. 381/400

(57) ABSTRACT

A magnetic system for an electroacoustic transducer, including an annular magnet which provides a magnetic field for a moving coil. The magnetic system has a first magnetic element forming a base plate and at least one second magnetic element forming a cover plate. The annular magnet is arranged between the first and second magnetic element. The annular magnet is held by the magnetic forces acting between the first magnetic element and the magnet, or between the magnet and the second magnetic element.

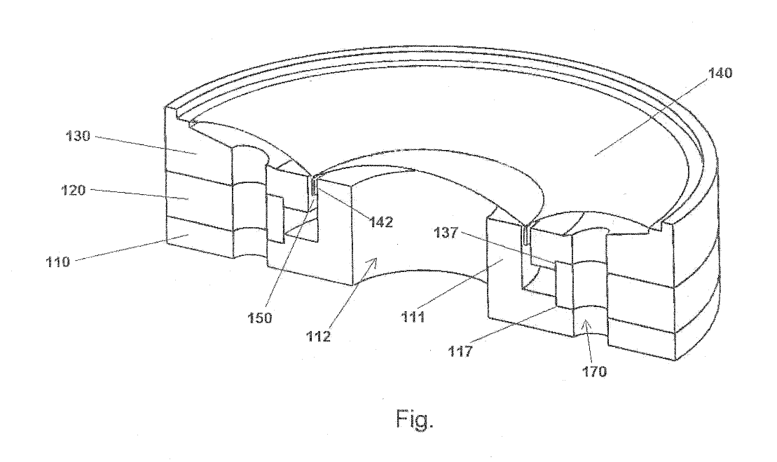

### BACKGROUND OF THE INVENTION

The invention relates to a magnetic system for an electroacoustic transducer according to the preamble of the independent claim.

A magnetic system for an electroacoustic transducer in which at least one magnet is provided which is formed in a plastic-bonded magnetic material and provides a magnetic field for a moving coil is disclosed for example in DE 10 2006 002 875 A1. An external and/or an inner partial volume are provided which is made from the plastic-bonded magnetic material, in which at least one magnet is formed with a predetermined polarity.

An electroacoustic transducer is further disclosed in DE-A-1 848 249 with an annular-gap magnetic system which comprises a base plate on which a cylindrical pole core is riveted. A centering ring is pressed concentrically onto the free end of the pole core during the assembly of the magnetic system. A magnetic ring which is coated with an adhesive is placed over the centering ring on the base plate. Thereafter, an upper pole plate which is provided with a bore is placed on the magnetic ring, with the same also being centered by means of the centering ring. The production of such a magnetic system is laborious and time-consuming. It requires a large number of production steps which are disturbing especially in the case of mass production. Moreover, a relatively long production process needs to be scheduled as a result of the required setting of glued parts.

An electroacoustic transducer which can be realized either as a loudspeaker or as a microphone is further disclosed in DE 29 33 630 C2. In this electroacoustic transducer, a magnetic ring is arranged between an upper base plate and a base plate with a pole core, with the base plate and the pole core being provided in an integral arrangement. The document does not provide any information on the mounting of the magnetic system. It can be assumed that the magnetic system is realized by gluing the magnetic ring with the base plate on the one hand and the upper pole plate on the other hand.

A headphone is disclosed in DE 26 02 128 A1, comprising a loudspeaker in which a magnetic ring is provided which is arranged between a base plate and an upper pole plate. The base plate and the pole core which has a central bore are realized in an integral configuration. A membrane is glued to the edge of a frame which is fastened to the upper pole plate.

DE 10 2008 010 298 A1 describes an electroacoustic transducer which can be arranged as a loudspeaker. It comprises an annular magnet which is arranged between a base plate with a pole core and an upper pole plate. The base plate and the pole core are realized in an integral configuration. The upper pole plate is connected in an interlocking manner with a separate frame, to which the membrane is fastened by gluing. The magnetic ring is also fastened by gluing.

The magnetic systems for electroacoustic transducers of the kind mentioned above all require a plurality of processing steps which are partly time-consuming, e.g., in the case of gluing and the setting periods in connection with the same.

### SUMMARY OF THE INVENTION

The invention is based on the object of providing a magnetic system for an electroacoustic transducer which can be produced in a simple, quick, and cost-effective way and offers good transmission quality of the sound signals.

The object is achieved in a magnetic system for an electroacoustic transducer. It is the fundamental idea of the invention to produce the magnetic system for an electroacoustic transducer by an adhesive-free joining process which uses the magnetic forces as holding forces for the individual components, i.e., a first magnetic element forming the base plate, an annular magnet, and a second magnetic element forming the cover element. The annular magnet is arranged between the first and second magnetic elements. The magnet is held by the magnetic forces acting between the first magnetic element and the magnet or between the magnet and the second magnetic element. Such an adhesive-free joining process which also does not require any other connecting elements can be produced with a very high precision and speed.

It is regarded as especially advantageous, for example, that the second magnetic element which forms the cover plate is used simultaneously for bearing a membrane. The membrane is fixed, in this case, to the second element, e.g., by an adhesive connection. In this way, the number of individual parts and the number of production steps are decreased even further.

For the purpose of an especially precise and simultaneously fast and simple mounting, it is advantageously provided that one positioning element each is provided on the first magnetic element forming the base plate and on the second magnetic element forming the cover plate for the purpose of positioning the annular magnet. The positioning element is a step, a protrusion, or the like, in the annular magnetic system which extends in the circumferential direction, for example. In this way, the parts are precisely positioned in the radial direction. They are held together by the magnetic force in the axial direction.

The first magnetic element forming the base plate and the second magnetic element forming the cover plate, preferably consist of a soft-magnetic material, especially iron. These two elements are advantageously made of a sintered material. Different shapes can thus be produced in an especially favorable manner and can be adjusted to predetermined dimensions and the like.

The annular magnetic is preferably a neodymium-iron-boron magnet. It can also be made as a sintered component.

The magnetic system is further preferably arranged in such a way that an annular gap is provided between the first magnetic element forming the base plate and the second magnetic element forming the cover plate or between the first magnetic element forming the base plate and the annular magnet and the second magnetic element forming the cover plate, with a moving coil arranged on the membrane dipping into said gap.

As already mentioned initially, the individual parts of the magnetic system consisting of the base plate, cover plate, and the annular magnet, are held against one another exclusively by the magnetic forces acting between them, with them being positioned precisely in the radial direction by the positioning elements. It can be provided merely as a mounting aid that the first magnetic element forming the base plate can be fixed to the second magnetic element for ining the cover plate, or the first magnetic element forming the base plate can be fixed to the annular magnet, and the annular magnet can be fixed to the second magnetic element forming the cover plate by means of adhesive spots.

An especially advantageous embodiment provides the annular magnet not as a separate part, but as an integral component of the second magnetic element forming the cover plate for example. Such an arrangement comes with the major advantage that the mounting of the magnetic system for an electroacoustic transducer can be made especially simply and rapidly by further reduction of the individual parts.

Further advantages and features of the invention are the subject matter of the following description and the illustrated representation of an embodiment of the invention. Individual features can be realized either separately or in combination with each other.

### BRIEF DESCRIPTION OF THE DRAWINGS

The drawing schematically shows a sectional view of a magnetic system for an electroacoustic transducer in the mounted state.

### DETAILED DESCRIPTION OF THE INVENTION

The magnetic system for an electroacoustic transducer in accordance with the invention as schematically shown in the drawing comprises a base plate (first magnetic element) 110, and annular magnet 120, and a cover plate (second magnetic element) 130. Both the base plate 110, as well as the cover plate 130, consist of a soft-magnetic material, e.g., of sintered iron. The annular magnet consists of a magnetically hard material, especially a neodymium-iron-boron material. As a result of the annular arrangement of the magnet, the magnetic flux density can be more than doubled over conventional, centrally-arranged magnets. Fields strengths over 1.2 Tesla can be achieved. Moreover, an annular magnet provides a central ventilation opening 112 through the pole core in order to prevent sound-distorting resonances and cancellations.

A membrane 140 is fastened to the cover plate 130, e.g., by a glued connection. This membrane 140 comprises a moving coil 142 which dips into a gap formed between the cover plate 130 and a central tubular projection 111 of the base plate 110. The membrane 140 can be made of a two-layer compound foil.

Both the first magnetic element 110 forming the base plate as well as the second magnetic element 130 forming the cover plate each comprise projections 117 and 137, respectively, which extend in the circumferential direction and on which the annular magnet 120 can be positioned. Since the magnetic system has the shape of a circular ring, such a circumferential projection represents a positioning element which enables a precise positioning of the annular magnet 120 on the base plate 110, or on the cover plate 130, in the radial direction. In the axial direction, the components are held against one another only by the magnetic forces exerted by the annular magnet 120 on the base plate 110 and the cover plate 130. Glued connections, screwed joints, riveted joints, and the like, can be omitted completely. This joining process which is free from gluing, screwing, riveting, and the like, not only enables a very simple and rapid production, but also a very precise one, because it is merely necessary to place three components on top of one another by considering the positioning elements 117, 137. It can be provided to arrange adhesive spots between the base plate 110 and the annular magnet 120, and between the ring magnet 120 and the cover plate 130, merely as a mounting aid in the sense that during the mounting process the required parts can inadvertently be separated from one another by exertion of an excessive tensile force. These adhesive spots are only used as a mounting aid, which needs to be stressed in particular. They are not required for the functional arrangement in accordance with the invention. Only the three components of base plate 110, ring magnet 120, and cover plate 130, need to be positioned on top of one another for arranging the magnetic system, which are then held together by the magnetic forces.

The membrane 140 is fastened in a final step to the cover plate 130. It can also principally be fastened beforehand. The membrane 140 can consist of a two-layer compound foil. This material allows high inner damping of partial oscillations despite its low weight and contributes to the transparent, finely defined, and distortion-free sound.

After placing the described magnetic components, the moving coil 142 arranged on the membrane dips into the gap 150 formed between the first magnetic element 110 and the second magnetic element 130, or the annular magnet 120.

It is expressly understood at this point that the annular magnet 120 does not have to be arranged as a separate component. It can also be provided that the annular magnet 120 is provided as an integral component of the second magnetic element 130 forming the cover plate, for example, which means forming the annular magnet in the same. In this case, the number of elements to be mounted decreases even further, so that the mounting speed will increase.

Several openings 170 are provided in the circumferential direction in the base plate 110, the annular magnet 120, and the cover plate 130, which openings are continuous in the mounted state, and are used for pressure equalization during operation of the magnetic system.

In summary, it is confirmed that the present invention enables a mounting of the magnetic system for an electroacoustic transducer without requiring the aid of connecting techniques such as glued connections, screwed joints, riveted joints, or the like. By producing the individual parts as sintered elements, a large variety of shapes, sizes, and the like, can be realized. As a result of the annular arrangement of the magnetic system for an electroacoustic transducer, the positioning elements can be realized in a very simple way and very precisely as steps, projections, grooves, or the like, which extend circumferentially in the manner of a circular ring.

It is especially noteworthy that the magnetic system for an electroacoustic transducer, as described above, can be arranged in a very small way, and thus, can also be used as an electroacoustic transducer for a headphone or as an electroacoustic transducer for a microphone.

1. A magnetic system for an electroacoustic transducer, comprising:
an annular magnet which provides a magnetic field for moving a coil;
a first magnetic element forming a base plate; and
a second magnetic element forming a cover plate, the annular magnet being arranged between the first and second magnetic elements so that the annular magnet is held by magnetic forces acting between the first magnetic element and the magnet, or between the magnet and the second magnetic element.

2. The magnetic system for an electroacoustic transducer according to claim 1, wherein a membrane is mounted on the cover plate.

3. The magnetic system for an electroacoustic transducer according to claim 2, wherein the membrane is glued on the cover plate.

4. The magnetic system for an electroacoustic transducer according to claim 2, wherein the membrane is a two-layer compound foil.

5. The magnetic system for an electroacoustic transducer according to claim 1, wherein at least one positioning element is arranged on the first magnetic element forming the base plate and on the second magnetic element forming the cover plate, for radial positioning of the annular magnet.

6. The magnetic system for an electroacoustic transducer according to claim 1, wherein the first magnetic element forming the base plate and the second magnetic element forming the cover plate, are made of a magnetically-soft material.

7. The magnetic system for an electroacoustic transducer according to claim 6, wherein the magnetically-soft material is iron.

8. The magnetic system for an electroacoustic transducer according to claim 1, wherein the first magnetic element forming the base plate and the second magnetic element forming the cover plate are made of a sintered material.

9. The magnetic system for an electroacoustic transducer according to claim 1, wherein the annular magnet is made of a neodymium-iron-boron material.

10. The magnetic system for an electroacoustic transducer according to claim 1, wherein the annular magnet is a sintered component.

11. The magnetic system for an electroacoustic transducer according to claim 2, wherein an annularly extending gap is located between the first magnetic element forming the base plate and the second magnetic element forming the cover plate, or between the first magnetic element forming the base plate and the annular magnet and the second magnetic element forming the cover plate, and further comprising a moving coil arranged on the membrane and extending into said gap.

12. The magnetic system for an electroacoustic transducer according to claim 1, wherein adhesive spots are provided as a temporary mounting aid to hold the first magnetic element forming the base plate to the second magnetic element forming the cover plate or the first magnetic element forming the base plate to the annular magnet, and the annular magnet to the second magnetic element forming the cover plate.

13. The magnetic system for an electroacoustic transducer according to claim 1, wherein the annular magnet is an integral component of the second magnetic element forming the cover plate.

14. The magnetic system for an electroacoustic transducer according to claim 1, wherein continuous openings are arranged in the first magnetic element forming the base plate, the annular magnet, and the second magnetic element forming the cover plate, which openings are aligned in a mounted state.
